(19) United States
(12) Patent Application Publication
(10) Pub. No.: US 2008/0257272 A1
(43) Pub. Date: Oct. 23, 2008

(54) DISINFECTING PET WATERING DEVICE AND METHOD

(76) Inventor: GERRY BOLDA, Victoria (CA)

Correspondence Address: J. GORDON THOMSON, P.O. BOX 8865, VICTORIA, BC, V8V 3Z1, CA

(21) Appl. No.: 11/736,945

(22) Filed: Apr. 18, 2007

(51) Int. Cl. A01K 7/00

(52) U.S. Cl. 119/72

(57) ABSTRACT

A continuously disinfecting pet watering device comprises a lower reservoir for holding a predetermined volume of water accessible to a pet and an upper reservoir in communication with the lower reservoir for holding a predetermined volume of replenishment water. A motorized pump is provided to re-circulate water through a filter and past a germicidal ultraviolet lamp for decontamination. The pump and lamp may be activated on demand by way of an animal proximity detector or they may operate periodically in a fixed or pre-programmed schedule. A method for a continuously disinfecting pet watering device is also disclosed.

### FIELD OF THE INVENTION

This invention generally relates to animal husbandry such as methods or apparatus for the general care of a living animal and more specifically supplying animals with drink.

### BACKGROUND OF THE INVENTION

Household pets have demonstrated a preference for fresh moving water. In cats this behavior can be seen in the kitchen or bathroom as begging for water from the faucet. Devices exist that allow the pet to drink from a recirculation system of water that is independent of household faucets and other plumbing means. These devices encourage the cat to drink water on a regular basis, which is good for the cat's overall health. There is plenty of evidence that cats that drink water on a regular basis have fewer incidents of Feline Urologic Syndrome. However, these devices do not address the problem of bacterial growth in the recirculation water system. Furthermore these devices are difficult to clean for the pet owner. Food particles, saliva enzymes, and bacteria all contribute to an overall slimy growth that adheres to every surface in the system. The bacterial growth in traditional drinking bowls increases over time. If the pet owner cleans and replaces the water daily the bacterial levels will be controlled. If however, the pet owner forgets to change the water on a regular basis the pet has no other choice than to drink stale stagnant and bacterial laden water. Therefore, there is a need for a pet watering device that is easy to clean and provides the animal with a source of water that does not contain deleterious levels of bacteria.

### SUMMARY OF THE INVENTION

The present invention relates to a new and novel device for providing a source of clean, fresh and disinfected water for a household pet. The invention is an electronic device that functions as a drinking bowl and fountain for pets. It contains an ultraviolet germicidal lamp that greatly reduces the bacteria presented to the pet. The invention operates on AC power. The water delivery system contains a bowl, a pump, a mechanical filter, and an ultraviolet germicidal lamp. In one example of the invention, the pump runs continuously and the UV lamp may also be active continuously. In another example of the invention the lamp may operate periodically to prolong lamp life. In another example of the invention, the pump and the UV lamp may run on a timed cycle. In still another example of the invention, the timed cycle may be set permanently in the invention logic or it can be adjustable by the user. In another example of the invention, the pump is running continuously to circulate water and a sensor system detects motion or presence of the animal when it is directly in front of the unit. The presence of the animal turns on the UV lamp for decontamination of drinking water. The water is delivered from an outlet below the water line. The water moving through the outlet creates a swirling motion in the bowl and this is attractive to cats that typically seek moving water as a drinking source. The water circulating through the system passes by the ultraviolet lamp so that a significant amount of the bacteria in the water is destroyed when the lamp is on. The pump and lamp can also be activated at preset intervals to maintain a minimum level of sterility in the water independent of the sensor or the presence of an animal. In one example of the invention this interval is adjustable by the pet owner and in another example of the invention it is preset in the invention logic. The activation sensor system may be, but is not limited to, one of the readily available low cost technologies such as passive infrared, active infrared, sonar, or Doppler radar. A gravity induced feed water system allows water delivery even in the absence of power. This feature allows the pet to continue to have access to the water bowl in the event of a power failure. A submersible and self-priming pump draws water from the lowest point in the system and pushes the water through various passages, including filters and UV lamps. In one example of the invention the pump motor is a brushless type electrical motor. In another example of the invention the pump motor may include brushes. The pump is typically an impeller type pump for minimum noise and maximum reliability. The pump will also have means to adjust the rate of flow of water circulating through the system in order to present the water to the pet according to its drinking preferences. A mechanical filter is used to trap and hold large particles of food and other debris before they enter the pump. This will prevent the pump from becoming damaged and reduce the amount of particles delivered to the pet from the nozzle. The filter will be easily removable to allow the pet owner to eliminate the trapped particles. The drinking bowl is easily removed from the main housing, and is made from high quality easy to clean material, such as, but not limited to stainless steel, ceramic or plastic. The bowl is shaped such that food falls (by gravity) towards the pump inlet area screen where the owner can easily remove the particles. In the operation of one example of the invention, a household pet approaches the device. The sensor on the device detects the motion of the animal and turns on the pump. The pump draws water up from the drinking area and pushes it through the various channels and filters and past the activated ultraviolet lamp for disinfecting. The water re-enters the drinking area. At periodic intervals (with or without the presence of the animal) the pump will start up in conjunction with the ultraviolet lamp and sterilize the water. The ultraviolet lamp may also be configured to turn on only when the pump is running. In this configuration the water entering the drinking bowl will be sterile. Other advantages and novel features of the present invention will become apparent in the following detailed description of the invention when considered in conjunction with the accompanying drawings.

### BRIEF DESCRIPTION OF THE DRAWINGS

FIG. 1 is an isometric view of a disinfecting pet watering device in accordance with an example of the present invention.

FIG. 2 is a partial sectional view in accordance with another example of the invention.

FIG. 3 is a sectional side view of a lower reservoir in accordance with another example of the invention.

FIG. 4 is an assembly view of one example of the invention.

FIG. 5 is one view of one example of the invention illustrating the replenishment reservoir apart from the housing.

FIG. 6 is a view of the bottom portion of the housing of one example of the invention.

FIG. 7 is the same view as FIG. 6 but with the filter removed.

FIG. 8 is a bottom view of the bottom portion of the housing as it engages the lower reservoir in one example of the invention.

### DETAILED DESCRIPTION

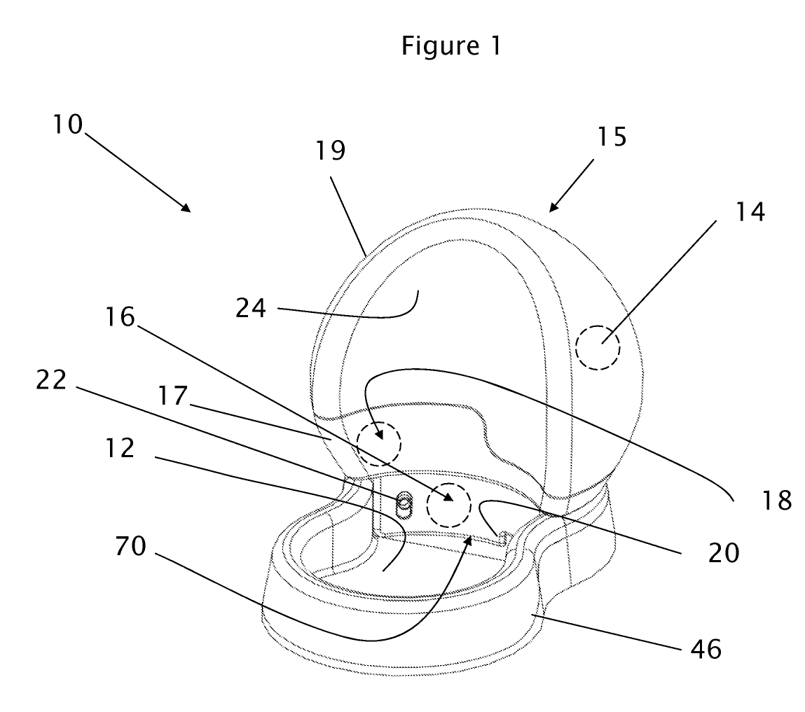

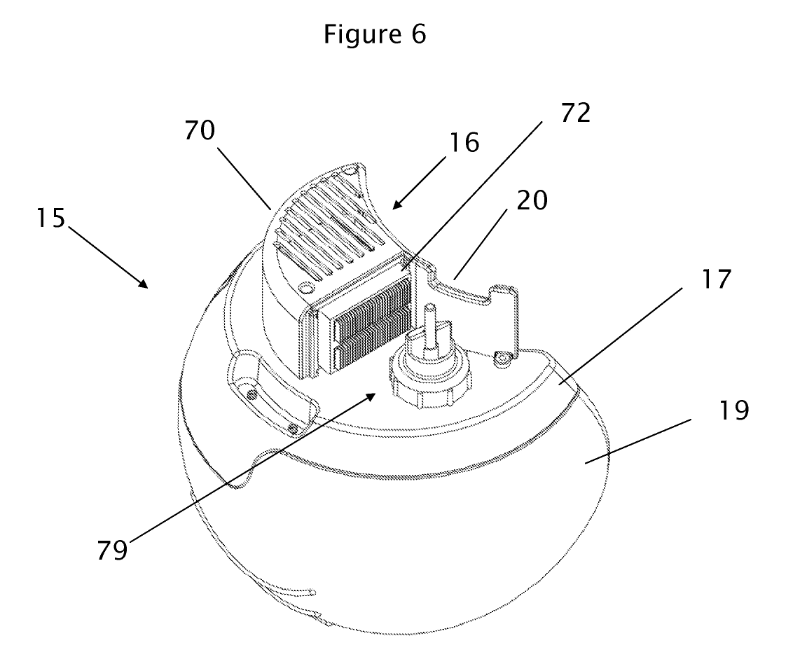

Referring to FIGS. 1 to 4, my invention (10) is a disinfecting pet watering device comprising a lower reservoir (12) for holding a first predetermined volume of water accessible to a pet and an upper reservoir (14) contained within (as denoted by the dash-lined circle) a semi-spherical-shaped housing (15). The upper reservoir (14) is in fluid communication with the lower reservoir and is adapted for holding a second predetermined volume of replenishment water. The housing (15) is generally one piece but for manufacturing purposes comprises a lower portion (17) and upper portion (19). Water recirculation means (16) is contained within the lower portion (17) of the housing for recirculating water in the lower reservoir to prevent stagnation. Water disinfecting means (18) is also contained within the lower portion (17) of the housing. FIG. 1 also illustrates recirculating water intake port (20) and outlet port (22). The water disinfecting means is in fluid communication with the water recirculation means. In another example of the invention there is included a proximity detector (FIG. 5 Item 60) for detecting the presence of a pet and engaging the water recirculation means and the water disinfecting means. Alternatively, a detector using radar or ultrasound could be mounted on the face (24) of the housing (15).

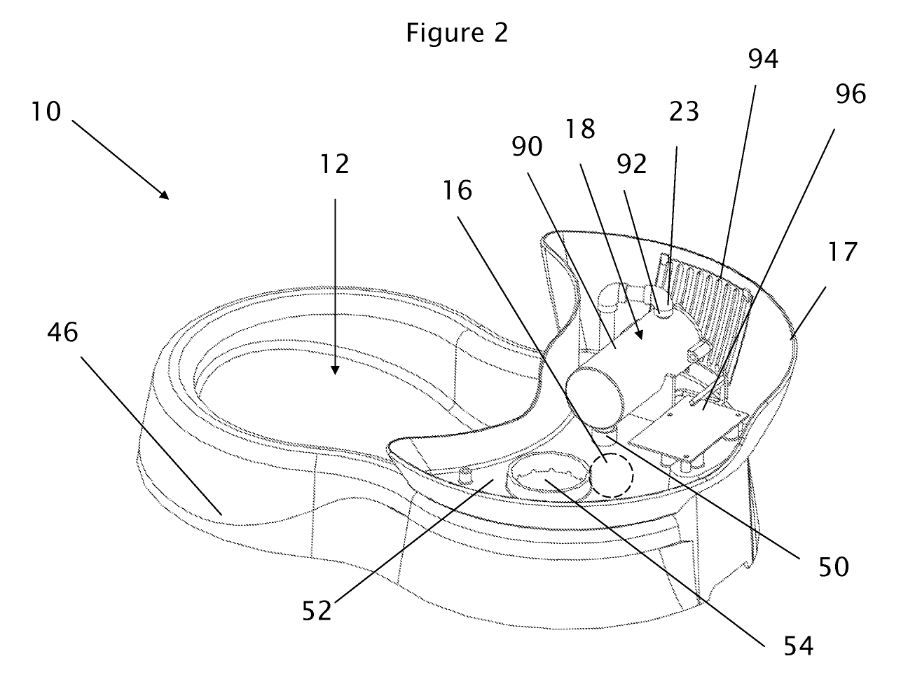

Referring now to FIG. 1 and FIG. 2, there is shown the lower reservoir (12) and the inside area of the lower portion (17) of the housing (15). The lower reservoir is manufactured from plastic, ceramic or preferably a high quality stainless steel which is known to impede the growth of algae on its surface. The lower reservoir is generally shaped as two overlapping circular bowls. The disinfecting means (18) is illustrated in fluid communication with the outlet port (22) by way of conduit (23). The water recirculation means (16) is located below the floor (52) of the lower portion (17) of the housing (15). The water disinfecting means is in fluid communication with the water recirculation means outlet by way of conduit (50). Also illustrated in FIG. 2 is the communications port (54) between the upper reservoir (14) and the lower reservoir (12).

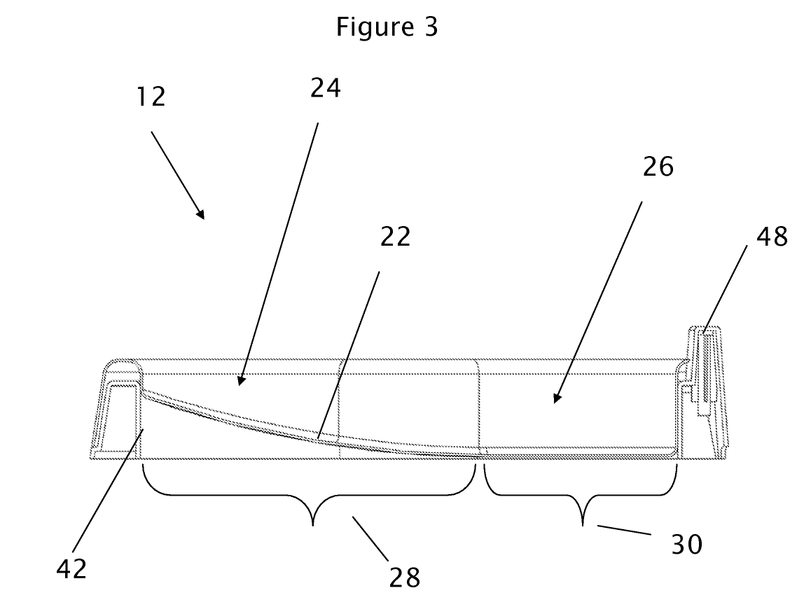

Referring to FIG. 3, the lower reservoir (12) has a bottom surface (22), a shallow end (24) for drinking and a deep end (26). The bottom surface has a sloping portion (28) traveling from the shallow end to the deep end to promote the migration of debris from the shallow end to the deep end. The bottom surface also has a flat portion (30) at the deep end (26) for seating housing (15) as illustrated in FIG. 1. Also illustrated in FIG. 2 is mounting plug (48) which contains electrical connections for both the water recirculation means and the water disinfecting means.

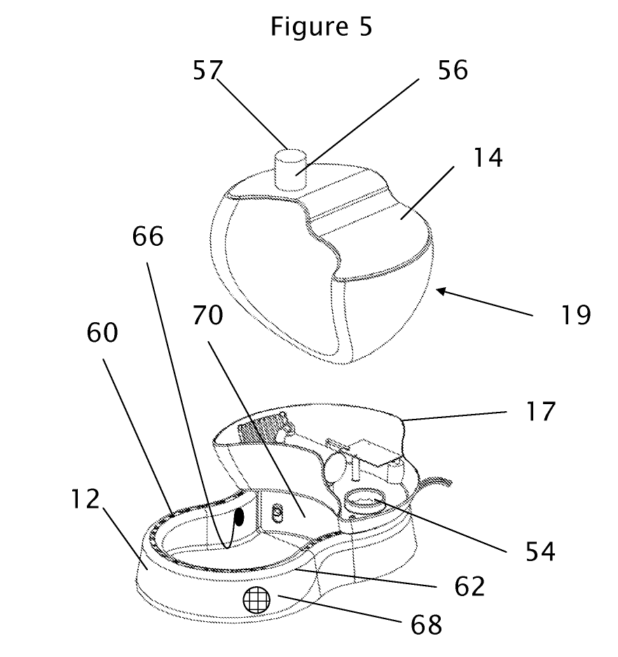

Referring now to FIG. 4, the lower reservoir (12) comprises a lower mounting frame (42) and an upper fluid containing vessel (44) that are press fit together for ease of manufacture. As well, in one example of the invention, the lower reservoir can be disassembled so the upper fluid containing vessel can be thoroughly cleaned separate from other components of the watering device. FIG. 4 also illustrates the recirculation means intake port (20) and the disinfecting means discharge port (22). FIGS. 1 and 2 show the seam line (46) between the lower mounting frame and the upper fluid containing vessel.

FIG. 4 illustrates mounting plug (48) that is used to provide electrical connections for the water recirculation means and the water disinfecting means as suggested by electrical cord (60). The housing (15) comprises the lower housing portion (17) and the upper housing portion (19). The upper and lower housings are fixed together during manufacturing. The entire housing (15) is separable from the lower reservoir (12) in order to replenish the upper reservoir (14) or replace the water recirculation means filter as more fully explained below. The housing (15) is typically fabricated from a suitable light and strong polymer.

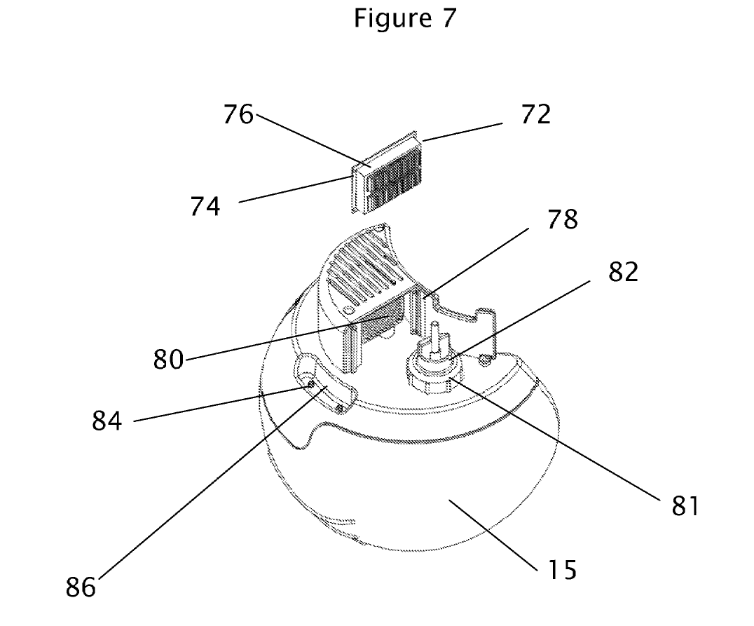

Now referring to FIG. 5, and in this example of the invention, the upper replenishment reservoir (14) is shown contained within the upper portion (19) of the semi-spherical-shaped housing (15). As more fully explained below, the replenishment reservoir (14) can be handily removed with the housing (15) to facilitate removal of internal components. The replenishment reservoir comprises a fluid communications conduit (56) that is adapted to seal-fit within port (54) so that the reservoir (12) will not go empty and maintains a constant level. Illustrated in FIG. 6 is water control means (79) to regulate the flow of water from the upper reservoir to the lower reservoir. FIG. 5 also illustrates one example of a proximity detector (60) which can be located on the upper surface (62) of the reservoir (12). In one example of the invention the lower reservoir (12) has a low water level sensor (68) and an audible and/or visual low level alarm (68) to alert the pet owner of a low water condition in the lower reservoir (12). In another example of the invention the upper replenishment reservoir (14) and the housing (15) material are translucent to permit viewing of the level of replenishment water.

Referring to FIGS. 4 and 5, the bottom portion (17) of the housing (15) comprises a sump portion (70) for submerging in the deep end (26) of the lower reservoir (12).

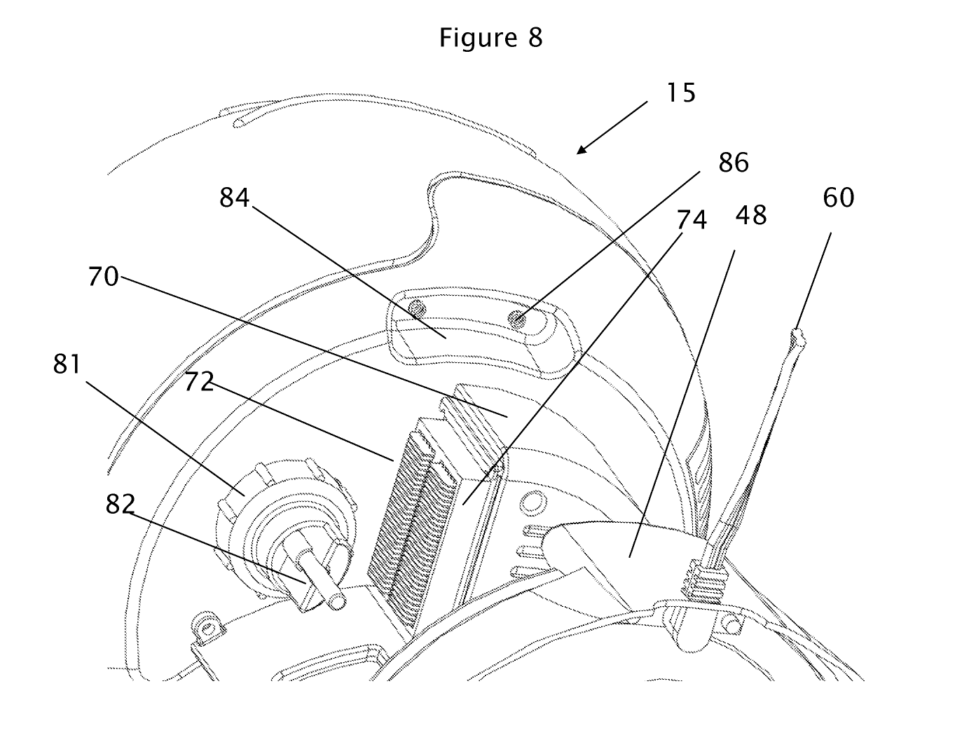

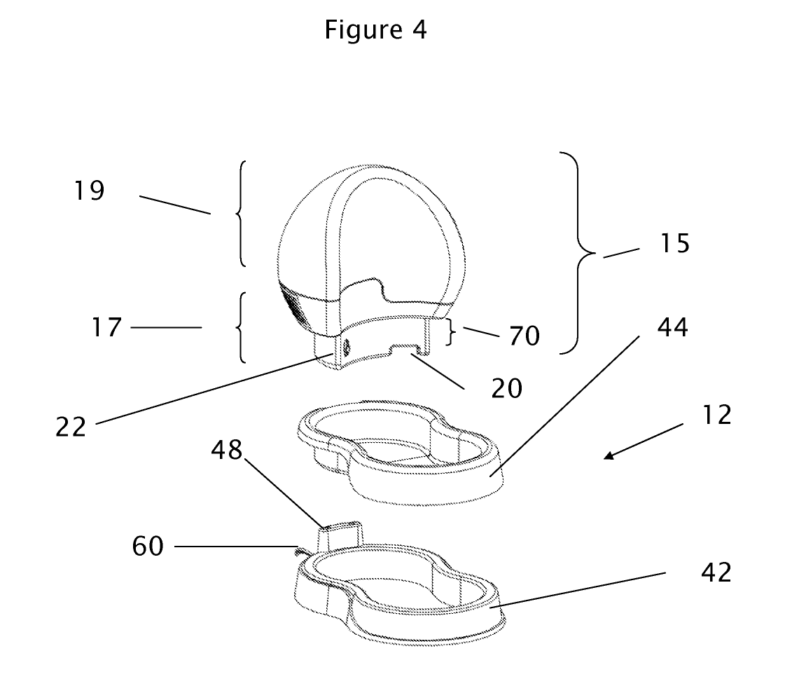

Referring now to FIG. 6, there is shown an inverted view of the housing (15) showing the sump portion (70) which contains water recirculation means (16). The water recirculation means comprises a pump motor and self-priming pump combination (46). The pump suction draws water from the reservoir (12) through the intake port (20). Pump discharge port (not shown) is connected to conduit (50) penetrating floor (52) of the lower portion (17). Conduit (50) is attached to the intake (not shown) of water disinfection means (18). There is further included a mechanical filter (72) that is removable (See FIG. 7) from the sump portion (70) by means of tabs (74) on the filter housing (76) that are adapted for sliding engagement with the grooves (78) on the sump portion (70). This permits the mechanical filter to be periodically cleaned and replaced as necessary. In this example of the invention the filter housing (76) fits within close proximity to the suction port (80) of the pump and so that debris free water can be drawing into the pump. The pump motor (44) can be AC or DC powered but in a preferred example of the invention it is AC powered. As well, the pump motor is preferably, but not exclusively, a brushless type electrical motor with an impeller type pump for maximum reliability and minimum noise. In one example of the invention the pump flow rate is constant. In another example of the invention the pump flow rate is adjustable to suit the drinking habits of the animal. The pump/motor set can be purchased as an off-the-shelf item such as a fountain pump or acquarium pump. The device also operates on a gravity feed basis so that if power to the pump fails, the lower reservoir will continue to be replenished with fresh water from the upper reservoir by way of flow control valve (82) mounted within the upper reservoir cap (81). The cap is easily removed for refilling the upper reservoir (14) and it can then be set upright in the lower reservoir (12) deep end (26) without spillage. Also illustrated in FIG. 7 are the electrical connections (84) mounted within the attachment groove (86) that is adapted to slide-fit with mounting plug (48) illustrated on FIG. 3, FIG. 4 and FIG. 8.

Referring back to FIG. 2, the water disinfection means (18) is disposed above the water recirculation means (16) and above floor (52). The water disinfection means (18) inlet is in fluid communication with the pump discharge by conduit (50). In this example of the invention, the water disinfection means comprises a cylindrical vessel (90) having an inlet (not shown) and an outlet (92). Within the vessel (90) is a source of germicidal non-ionizing radiation (not shown). As water is re-circulated though the vessel it flows past this source of non-ionizing radiation and is disinfected. In a preferred example of the invention, the source of non-ionizing radiation is a ultra-violet light source having germicidal properties. The light source is AC powered and an access door (94) is provided in the side of the housing, to allow replacement of the lamp (15) adjacent to the vessel (90). Conduit (23) is in fluid communication with the discharge port (22) in the deep end (26) of the lower reservoir (12). In one example of the invention, the discharge port (22) is adjustable so that water entering the lower reservoir may enter below the surface of the water or alternatively it may breach the water's surface in a fountain effect. This fountain effect has the benefit of attracting the animal to moving water and encouraging increased consumption of clean water which is healthful.

Referring back to FIG. 5, the optional proximity detector (60) is adapted to activate the pump and ultra-violet light source for a pre-determined period of time after which they are then disengaged. As well, the pump and ultra-violet light source may be activated from time to time on a fixed or optionally operator pre-programmed schedule so that the water is maintained in a sterile condition for drinking even if the animal does not activate the proximity detector. Operator pre-programming and any other automatic functions of the device can be controlled by means of a circuit board (96) mounting suitable components for these functions and in electrical communication with the water recirculation means and water disinfecting means. The proximity detector can be a technology such as Doppler radar or active or passive infra-red sonar. When installed in the device, the proximity detector will only activate the lamp when the animal is present or according to an activation program. Therefore, the amount of noise from the pump is minimized.

A method of germicidal treatment of pet drinking water comprises:
a. providing an open source of the pet drinking water;
b. providing a closed source of replenishment water in communication with the open source of pet drinking water;
c. providing means for circulating pet drinking water from the open source into a closed vessel having a germicidal lamp therein;
d. activating the circulating means and the germicidal lamp in combination;
e. circulating water from the open source into the closed vessel, wherein the activated germicidal lamp sterilizes pet drinking water;
f. discharging the sterilized pet drinking water into the open source; and,
g. replenishing the open source from the closed source as necessary.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. A disinfecting pet watering device comprising:
a. a lower open reservoir for holding a first predetermined volume of water accessible to a pet;
b. a refillable closed upper reservoir in communication with said lower open reservoir for holding a second predetermined volume of replenishment water;
c. water recirculation means for circulating water in the lower reservoir to prevent stagnation and attract said pet; and,
d. water disinfecting means in fluid communication with said water recirculation means.

2. The device of claim 1 further including a proximity detector for detecting the presence of the pet and activating said pet watering device.

3. The device of claim 1, wherein the lower reservoir is made from stainless steel.

4. The device of claim 3, wherein the lower reservoir comprises a bottom surface comprising a shallow end for drinking and a deep end for mounting said refillable upper reservoir.

5. The device of claim 4, wherein said bottom surface further comprise a sloping portion traveling from said shallow end to said deep end in order to promote the migration of debris from the shallow end to the deep end so that an operator may retrieve said debris.

6. The device of claim 5, wherein the bottom surface further comprises a flat portion at the deep end for seating the refillable upper reservoir.

7. The device of claim 6 wherein the refillable upper reservoir, said water recirculation means and said water disinfecting means are contained in a housing.

8. The device of claim 7, wherein said housing comprises an upper portion and a lower portion and wherein said upper portion and said lower portion are separable.

9. The device of claim 8 wherein the lower portion further comprises a sump portion for housing the water recirculation means.

10. The device of claim 9, wherein the upper portion contains the refillable closed upper reservoir.

11. The device of claim 10 wherein the upper portion and the lower portion are removable from the lower open reservoir as a single piece.

12. The device of claim 11, wherein the upper reservoir is in fluid communication with the lower open reservoir by a fluid communications conduit having a discharge port.

13. The device of claim 12 wherein water flow from the refillable closed upper reservoir to the lower open reservoir is controlled by water flow control means.

14. The device of claim 13 wherein said water flow control means comprises a water flow control valve mounted within a cap adapted to close said upper reservoir discharge port.

15. The device as claimed in claim 14 wherein the water flow control means ensures that water flows from the upper closed reservoir to the lower open reservoir at a suitable rate so as to maintain a steady level of water within the lower open reservoir.

16. The device of claim 14 wherein the water flow control means ensures gravity induced flow of water from the upper closed reservoir to the lower open reservoir.

17. The device of claim 16 further including a low water level sensor and alarm for detecting and alarming low water level in the lower open reservoir.

18. The device of claim 1 wherein said water recirculation means comprises a pump motor connected to a pump having a suction port and a discharge port.

19. The device of claim 18 wherein the water recirculation means further comprises a filter and filter housing adapted to prevent debris from entering said suction port.

20. The device of claim 19, wherein said filter and filter housing is removable from the sump portion so that the filter and filter housing can be cleaned and replaced.

21. The device of claim 20, wherein said water disinfection means comprises a closed vessel comprising an intake port and an outlet port, and wherein said intake port is in fluid communications with said pump discharge and wherein the water disinfection means outlet port discharges into the lower open reservoir.

22. The device of claim 21, wherein said closed vessel contains germicidal means vessel for destroying bacteria in water flowing proximate to said germicidal means.

23. The device of claim 22, wherein the germicidal means comprises a source of non-ionizing radiation.

24. The device of claim 23, wherein said source of non-ionizing radiation is a ultra-violet light source.

25. A method of germicidal treatment of pet drinking water using a UV lamp comprising:
a. providing an open reservoir of said pet drinking water;
b. providing a closed reservoir of replenishment water in communication with said open reservoir;
c. providing means for circulating the pet drinking water from the open reservoir into and through a closed vessel having germicidal means therein so that the pet drinking water in proximity to said germicidal means is disinfected;
d. activating said pet drinking water circulating means and said germicidal means in combination;
e. circulating pet drinking water from the open reservoir into said closed vessel for sterilization;
f. discharging sterilized pet drinking water into the open reservoir; and,
g. replenishing the open reservoir from said closed reservoir as necessary.

26. The method of claim 25 wherein the germicidal means is a ultra-violet light source.
